(19) United States
(12) Patent Application Publication
(10) Pub. No.: US 2008/0225653 A1
(43) Pub. Date: Sep. 18, 2008

(54) Method for Storing Information on a Storage Medium

(75) Inventors: Philip Steven Newton, Eindhoven (NL); Petrus Nicolaas Wouters, Eindhoven (NL); Sander Rudolfus Kooijmans, Eindhoven (NL); Koen Johanna Guillaume Holtman, Eindhoven (NL); Hendrik Frank Moll, Eindhoven (NL); Michiel Josephus Christianen, Zundert (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/089,730

(22) PCT Filed: Oct. 6, 2006
(86) PCT No.: PCT/IB2006/053666

§ 371 Date: Apr. 10, 2008

(30) Foreign Application Priority Data
Oct. 13, 2005 (EP) 05109538.8

(51) Int. Cl. G11B 7/007

(52) U.S. Cl. 369/30.07

(57) ABSTRACT

A method for recording a movie (30) is described, the method comprising the steps of: —receiving a broadcasted video stream (10; 31); —recording the received video stream on an information carrier (2RE); —receiving additional metadata (32), preferably via internet (40); —recording the received metadata (32) on the information carrier (2RE) in association with the video recording (31).

### FIELD OF THE INVENTION

The present invention relates in general to a method for storing information on a storage medium. Especially, the present invention relates to a method for storing a video recording on a BD-RE disc, and the invention will be explained specifically for this field, but the gist of the invention is not restricted to this field.

### BACKGROUND OF THE INVENTION

As is known to persons skilled in the art, an optical storage disc comprises at least one track, either in the form of a continuous spiral or in the form of multiple concentric circles, of storage space where information may be stored in the form of a data pattern. Optical discs may be read-only type, where information is recorded during manufacturing, which information can only be read by a user. The optical storage disc may also be a writable type, where information may be stored by a user. For reading information from the disc, an optical disc drive comprises, on the one hand, rotating means for receiving and rotating an optical disc, and on the other hand optical scanning means for generating an optical beam, typically a laser beam, and for scanning the storage track with said laser beam. Since the technology of optical discs in general, the way in which information can be stored in an optical disc, and the way in which information can be read from an optical disc, is commonly known, it is not necessary here to describe this technology in more detail.

The technology of optical discs has seen several disc types, such as CD, DVD. The next generation, currently under development, is the Blu-Ray Disc. In this new type of optical disc, a read-only version (BD-ROM) will be available as known from for example the international patent application publication WO2004/025651. Also recordable discs are under development, indicated as BD-RE and known from for example the US Patent Application Publication US20040240848.

The primary application for the Blu-Ray Disc will be High Definition Television (HDTV). Basically, this involves playback and display and, in the case of a recordable disc, the function of recording a broadcast. However, the standard for BD-ROM also provides for additional functionality, such as internet-connectivity and user-interactivity. For effecting such additional functionality, a BD-ROM will contain, apart from the “normal” content (i.e. the movie(s)), additional movie-related data, indicated as metadata, defining one or more executable applications and/or data bases, and BD-ROM players will be designed for reading such executable applications from the disc and executing the applications. Typically, the applications will be based on Java, but other languages are also possible.

A producer of the BD-ROM disc (content author) is free to decide whether or not he will add such additional functionality to the disc, but it is to be expected that many producers will. As a simple example of the possibilities, a menu can be generated allowing the user to more easily control the playback of the movie. Such menu may, for instance, enable a user to directly jump to the start of a specific scene identified in the menu. Depending on the type of movie, it is even possible that the viewer is allowed to participate in the movie, influencing the course of the movie. For instance, the movie may have a fighting scene, and the viewer may “shoot” comparable to a game. The “effect” of his shooting may be projected graphically over the actual movie images; or, it is possible that the BD-ROM disc contains several versions of the scene, and the viewer's shooting may result in a specific version of the scene being selected by a suitable change in the playlist.

When a user buys a movie on a BD-ROM disc, he profits from all the enhanced functionality provided by the disc producer. However, the costs of such movie are relatively high. Further, a movie may be unavailable as BD-ROM disc.

Alternatively, a user may wish to record a broadcast of a movie. As compared to buying a movie on a BD-ROM disc, the costs will be lower. However, the format for recordable Blu-Ray discs only supports very basic recording of a video transport stream; particularly, this format does not support disc navigation and/or menus and/or other enhanced functionality available in the case of BD-ROM discs. Further, when a movie is being broadcast, the broadcast does not contain the said metadata necessary for providing the additional functionality offered with the BD-ROM version of the movie. Nevertheless, the user may desire to have added functionality compared to functionality he has seen for BD-ROM discs.

The present invention aims to solve the above problems. Specifically, the present invention aims to combine the advantages of recording a broadcast movie on a BD-RE disc with the advantages of at least some of the additional functionality offered with the BD-ROM version of the movie.

### SUMMARY OF THE INVENTION

In an important aspect, the present invention provides a method for adding metadata to a movie recorded from a broadcast. On playback, a player will not just play the recorded video stream but will consult the metadata also recorded on the disc.

The metadata define all information necessary to make the movie recording BD-ROM compliant. In such case, all advantageous functionalities supported by BD-ROM are available for the recording.

The metadata will typically be provided by the producer of the movie, against payment of a small fee. Thus, the producer is free to decide if the metadata available for BD-RE recordings provides the same functionality as the BD-ROM version of the movie, or that the BD-ROM version of the movie still offers more functionality, such as to stimulate users to buy the more expensive BD-ROM.

In a possible embodiment, a disc drive has internet-connectivity, and is capable of visiting a website with available metadata. The website may for instance be a website maintained by the producer of the movie, or a website maintained by a third commercial party. The disc drive downloads metadata, possibly after payment has been arranged, and stores the metadata into a memory, so that it can be used for playing the corresponding movie. The metadata to be downloaded can be selected by the user, but it is also possible that the disc drive recognizes the viewer's video movie on the disc and automatically selects the corresponding metadata.

In another possible embodiment, the metadata may be available on a data carrier, for instance a BD-ROM disc. In such case, the user may first load this BD-ROM disc into his player, select the required metadata, have the player store the metadata into its memory, and then load the BD-RE disc with the recorded movie: the additional functionality is then available based on the metadata in the player's memory.

In a preferred embodiment, the additional metadata (whether read from a BD-ROM disc or downloaded via internet) is also written to the BD-RE disc with the recorded movie: then, this disc can be read as a BD-ROM disc by any BD-ROM player.

Instead of obtaining the metadata after the movie has been broadcast and recorded, it is also possible that the required metadata is already stored on the (empty) BD-RE disc. The idea is that such BD-RE disc with pre-recorded metadata will be somewhat more expensive than blank discs, so that with the added price the user pays for the automatic feature of BD-ROM functionality. This applies, of course, only if the user records a broadcast of the movie corresponding to the metadata. There may even be a function warning the user if he tries to record a movie not corresponding to the metadata pre-recorded; there may even be a function preventing such recording. It is noted that the recording capacity of such BD-RE disc is large enough to contain metadata relating to more than one movie.

Effectively, such empty BD-RE disc with pre-recorded metadata will, after recording, behave comparably to a BD-ROM disc containing the same movie, i.e. providing all advantageous functionality added to a BD-ROM version of the movie, yet combined with the advantages and flexibility of a recordable disc.

### BRIEF DESCRIPTION OF THE DRAWINGS

These and other aspects, features and advantages of the present invention will be further explained by the following description with reference to the drawings, in which same reference numerals indicate same or similar parts, and in which:

FIG. 1A schematically illustrates a BD-ROM disc;

FIG. 1B is a block diagram schematically illustrating a BD-ROM disc being played by a BD-ROM player;

FIG. 2A schematically shows a movie broadcast being recorded to a BD-RE disc;

FIG. 2B is a block diagram schematically illustrating a BD-RE disc being played by a player;

FIGS. 3A-B are block diagrams schematically illustrating a first implementation of the present invention, where a disc player receives metadata via Internet to add BD-ROM functionality;

FIGS. 4A-B are block diagrams schematically illustrating a second implementation of the present invention, where a disc drive device receives metadata via internet and writes this metadata to the disc to add BD-ROM functionality, so that the disc can be treated as a BD-ROM disc by a BD-ROM player;

FIGS. 5A-B are block diagrams schematically illustrating a third implementation of the present invention, where an empty disc is provided with metadata, either pre-stored thereon on downloaded via internet, and then a movie broadcast is recorded to this disc.

### DETAILED DESCRIPTION OF THE INVENTION

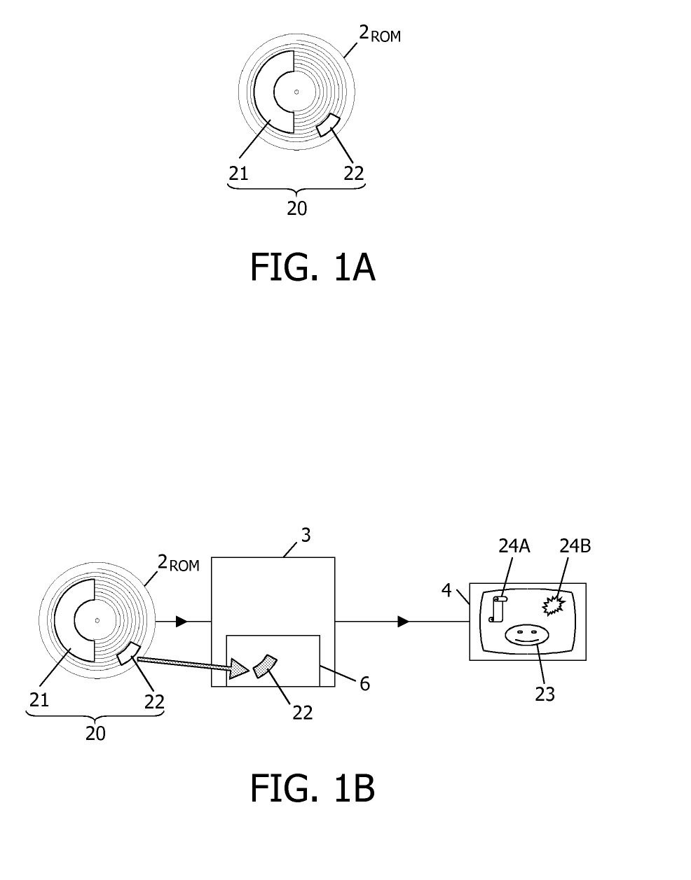

FIG. 1A schematically illustrates a BD-ROM disc 2_{ROM}, containing a movie 20 comprising actual video data 21 as well as metadata 22 for providing additional functionality. Since such BD-ROM discs and the way in which video data and metadata are recorded are known per se, it is not necessary to explain this in further detail.

FIG. 1B is a block diagram schematically illustrating this BD-ROM disc 2_{ROM} being played by a BD-ROM player 3. After receiving a user command to playback the movie 20, the player 3 may first read the metadata 22 of this movie 20 and store this metadata 22, or a part thereof, into an operation memory 6. Then, the player 3 starts reading the video data 21 of this movie 20 and, on the basis of the video data 21 and metadata 22, generates a display signal for a display device 4, typically a monitor. Apart from the actual movie images, indicated by a symbol 23, the display may have additional functionality, such as for instance a display menu indicated by a symbol 24A, or user interactivity indicated by a symbol 24B.

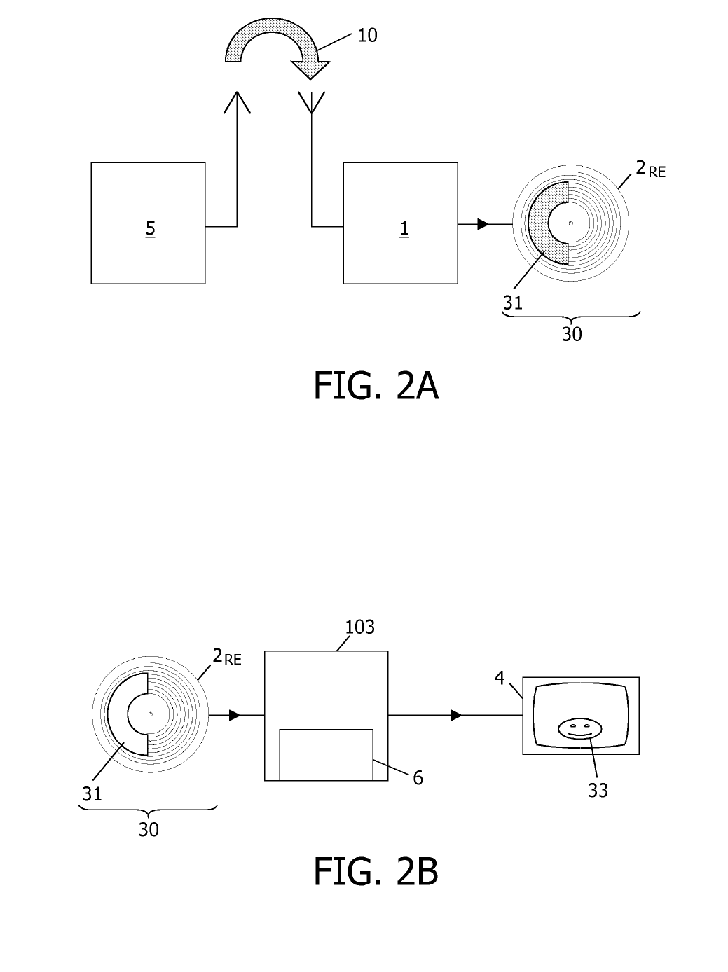

FIG. 2A schematically shows a movie broadcast 10 being transmitted by a broadcaster 5 and received by a recording device 1, recording the received broadcast data to a BD-RE disc 2_{RE}. The recorded broadcast movie is schematically indicated at 30. When comparing with FIG. 1A, FIG. 2A illustrates that the broadcast data 10 only comprise the “bare” movie, i.e. actual video data 31.

FIG. 2B is a block diagram schematically illustrating this BD-RE disc 2_{RE} being played by a player device 103.

After receiving a user command to playback the movie 30, the player 3 starts reading the video data 31 of this movie 30 and, on the basis of the video data 21 only, generates a display signal for a display device 4. Display now only involves actual movie images, indicated by a symbol 33; the additional functionality offered by BD-ROM discs is not supported here, and the player 3 can only play the bare movie from the begin till the end.

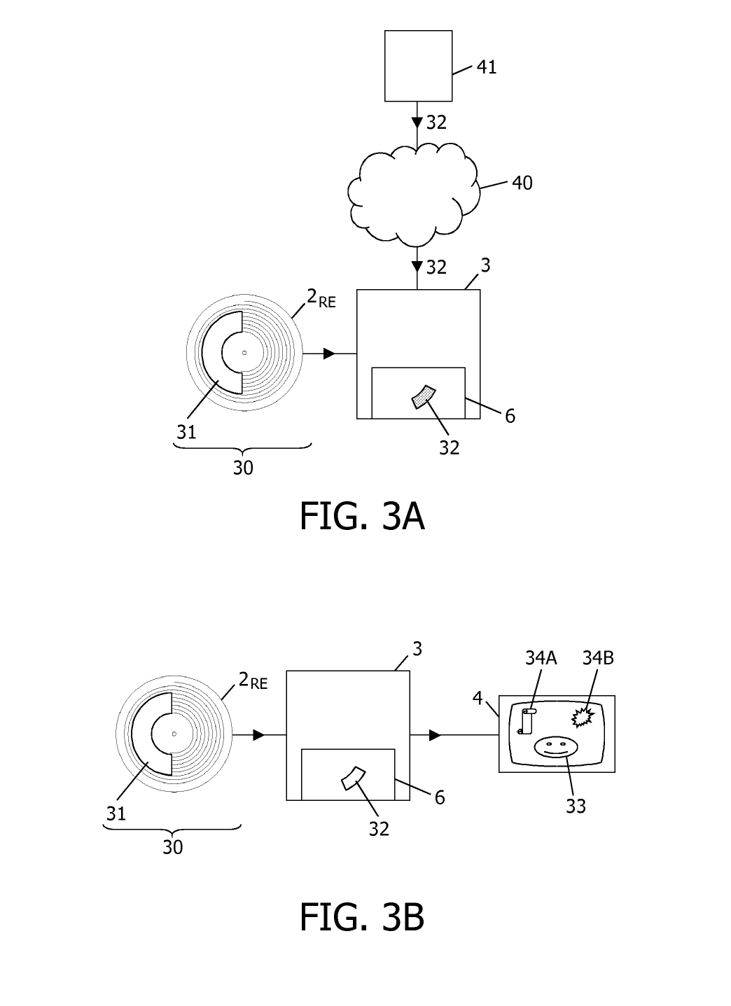

FIG. 3A is a block diagram schematically illustrating a first implementation of the present invention. The BD-RE disc 2_{RE} containing only the video data 31 of the movie 30, obtained by recording the broadcast 10 of FIG. 2A, is introduced into a disc drive 3 with internet connectivity. Via Internet 40 or another network, this disc drive 3 is connected to a web site 41 of a metadata provider. Although the metadata provider may be any commercially operating company, for the sake of discussion it will be assumed that the metadata provider is the broadcaster of the broadcast 10. Alternatively, the metadata provider may also be the producer of the movie 30.

Connection to the website 41 can be made manually by the user. However, in a preferred embodiment, this is done automatically by the player 3. As will be known to persons skilled in the art, every movie contains data regarding title, producer, etc. After receiving a suitable command from the user, the disc drive 3 is capable of consulting this data in the data 31, recognizing the movie involved, and recognizing which metadata provider provides suitable metadata for the recording 30. The disc drive 3 is further capable of accessing the website of this metadata provider and, possibly after having performed an internet payment in a manner known per se and not important for understanding the present invention, downloading metadata 32 and storing it into its operation memory 6.

After having completed the download, the disc drive 3 uses this downloaded metadata for providing BD-ROM functionality to the recording 30, as illustrated in FIG. 3B. The disc drive 3 starts reading the video data 31 of this movie 30 from disc 2_{RE} and, on the basis of the video data 31 and the metadata 32 in its operation memory 6, generates a display signal for display device 4. Apart from the actual movie images 33, as would have been available on the basis of the video data 31 only, the disc drive 3 now provides additional BD-ROM functionality, such as for instance a display menu 34A, or user interactivity 34B.

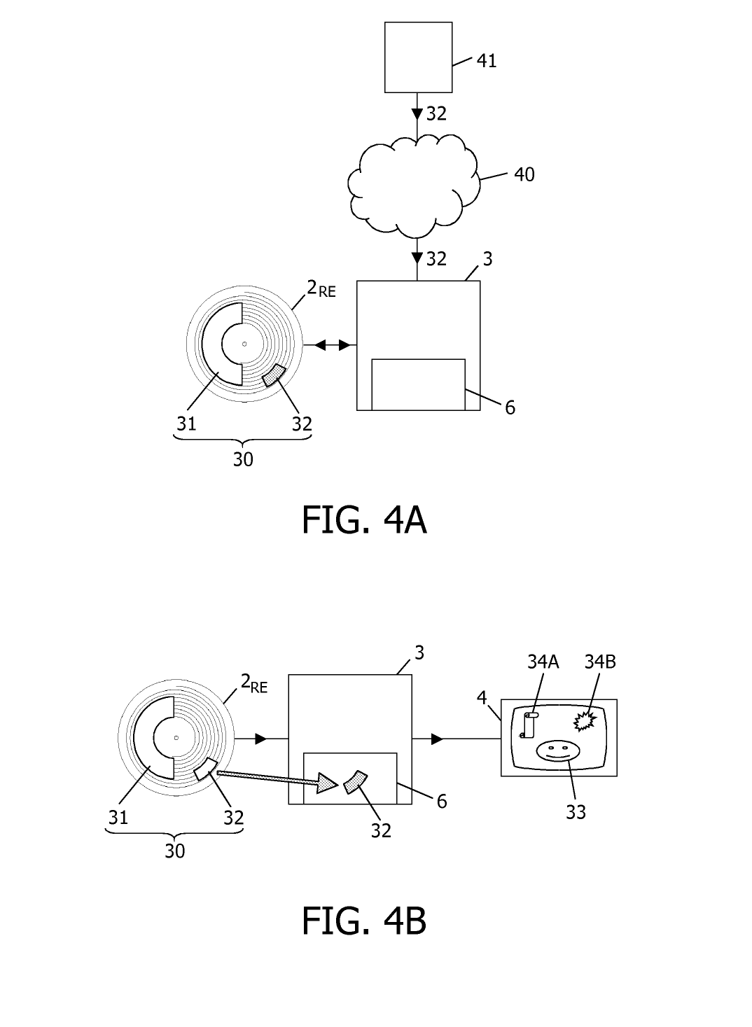

FIG. 4A illustrates a preferred embodiment of the invention, where the disc drive device 3 writes the downloaded metadata 32 to the BE-RE disc 2_{RE}, for future use and/or repeated use. When the download has been completed, the BE-RE disc 2_{RE} contains both the video data 31 and the associated metadata 32 of the movie 30. The BE-RE disc 2_{RE} can now be treated as a BD-ROM disc by any BD-ROM player; to the user, the results will be the same as compared to loading a BD-ROM disc. This is illustrated in FIG. 4B. The BE-RE disc 2_{RE} is loaded into a BD-ROM player 3. After receiving a user command to playback the movie 30, the player 3 may first read the metadata 32 of this movie 30 and store this metadata 32, or a part thereof, into its operation memory 6. Then, the player 3 starts reading the video data 31 of this movie 30 and, on the basis of the video data 31 and metadata 32, generates a display signal for the display device 4. Apart from the actual movie images 33, the display may have the additional BD-ROM functionality 34A and/or 34B.

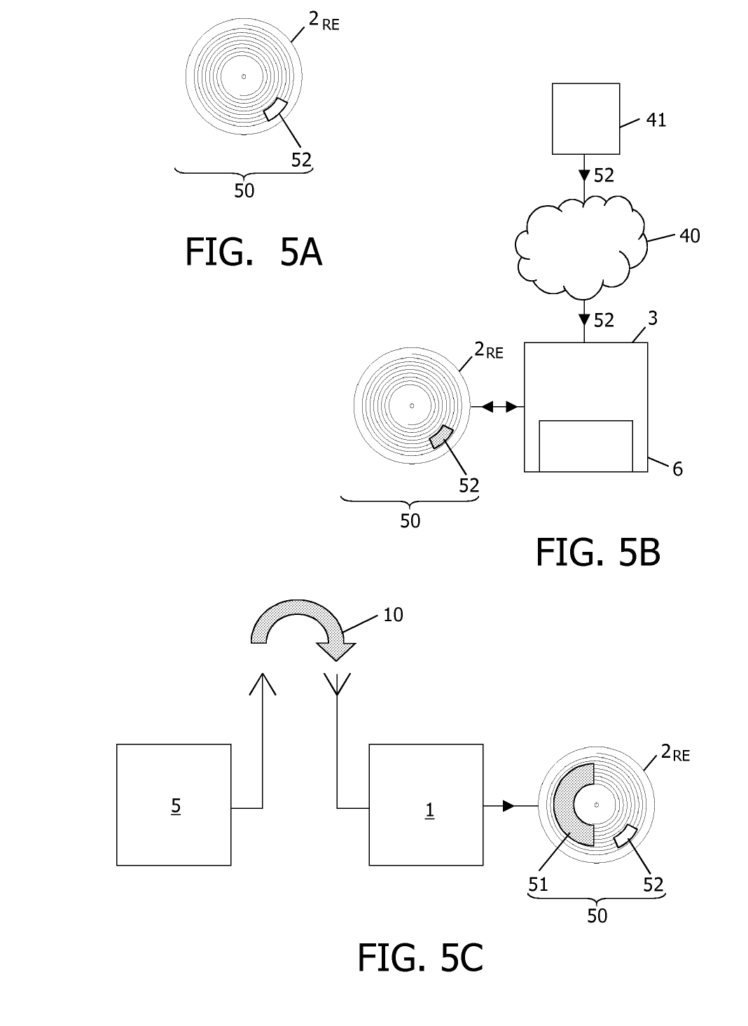

Another implementation of the present invention is schematically illustrated in FIGS. 5A-C. FIG. 5A schematically illustrates an empty recordable BD-RE disc 2_{RE} which already contains metadata 52 pre-stored thereon, which is preferably copy protected so that this metadata 52 cannot be copied. The BD-RE disc 2_{RE} may contain metadata 52 associated with one movie 50 only, but the BD-RE disc 2_{RE} may also contain metadata 52 associated with a plurality of movies.

In a practical example, a broadcasting company may sell such discs, containing metadata associated with all movies this broadcasting company is going to broadcast within a certain time period of, for instance, one month. It is also possible that the disc contains metadata associated with all movies of a certain series. By paying for this disc, the buyer obtains permission to record those movies in association with the metadata in order to upgrade the broadcast movie to a BD-ROM movie. The disc may contain an application which, on execution, will check that the movie which is to be recorded corresponds to an “allowed” movie mentioned in a list on the disc or corresponds to one of the metadata.

Alternatively, comparable to what was described with reference to FIG. 4A, a user may download metadata 52 from a website and write the information to an empty recordable BD-RE disc 2_{RE}, as illustrated in FIG. 5B.

In both cases, the user may use the empty recordable BD-RE disc 2_{RE}, containing the metadata 52, for recording the video data 51 of the corresponding movie 50, as illustrated in FIG. 5C, which compares to FIG. 2A. As a result, the user will have obtained a BE-RE disc 2_{RE} containing the combination of the video data 51 and the associated metadata 52. The BE-RE disc 2_{RE} can now be treated as a BD-ROM disc by any BD-ROM player (compare FIG. 4B); to the user, the results will be the same as compared to loading a BD-ROM disc.

If desired, after having played the movie 50, the user may delete the video data 51 of the movie 50 and record another one instead, corresponding to another pre-stored metadata.

It should be clear to a person skilled in the art that the present invention is not limited to the exemplary embodiments discussed above, but that several variations and modifications are possible within the protective scope of the invention as defined in the appending claims.

It is noted that, in the above, for the sake of explaining the invention, a disc has been called “empty” when it does not yet contain the video data of the broadcast it is intended to record. In the context of FIG. 5A-C, the disc does contain metadata. Further, it may be that the disc contains other recordings, which play no role in applying the invention.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Method for recording a movie (30), the method comprising the steps of:
receiving a broadcasted video stream (10; 31);
recording the received video stream on an information carrier (2_{RE});
receiving additional metadata (32);
recording the received metadata (32) on the information carrier (2_{RE}) in association with the video recording (31).

2. Method according to claim 1, wherein the information carrier (2_{RE}) is an optical disc, specifically a BD-RE disc.

3. Method according to claim 1, wherein the metadata (32) is received through a communication network, for instance internet (40).

4. Method according to claim 1, wherein the metadata (32) defines BD-ROM functionality.

5. Method for adding metadata to video data (31) of a movie (30) recorded on an information carrier (2_{RE});
the method comprising the steps of receiving the metadata (32) through a communication network, for instance internet (40), and recording the received metadata on the information carrier (2_{RE}) in association with the video data (31).

6. Method according to claim 5, wherein the metadata (32) is selected to match with the video data (31) on the information carrier (2_{RE}), and wherein the metadata (32) defines BD-ROM functionality for the information carrier (2_{RE}).

7. Method according to claim 5, wherein the information carrier (2_{RE}) is an optical disc, specifically a BD-RE disc.

8. Method for playing video data (31) of a movie (30) recorded on an information carrier (2_{RE}), the method comprising the steps of:
through a communication network, for instance internet (40), receiving metadata (32) associated with the movie (30);
storing the metadata (32) in an operation memory (6);
on the basis of the metadata (32) stored in said operation memory (6), reading the video data (31) from the information carrier (2_{RE}), and displaying the corresponding images on a display (4).

9. Method for playing video data (31) of a movie (30) recorded on an information carrier (2_{RE}), the method comprising the steps of:
through a communication network, for instance internet (40), receiving metadata (32) associated with the movie (30);
recording the received metadata on the information carrier (2_{RE}) in association with the video data (31);
on the basis of the metadata (32) recorded on the information carrier (2_{RE}), reading the video data (31) from the information carrier (2_{RE}), and displaying the corresponding images on a display (4).

10. Method according to claim 9, wherein the metadata (32) defines BD-ROM functionality.

11. Method for recording a movie (30; 50) comprising video data (31; 51) and metadata (32; 52), the method comprising the steps of:
providing a recordable information carrier (2_{RE});
in a first recording step, recording the video data (31; 51);
in a separate second recording step, recording the metadata (32; 52) in association with the video data (31; 51).

12. Method according to claim 11, wherein the first recording step is executed before the second recording step.

13. Method according to claim 11, wherein in the first recording step the video data (31) is received from a broadcast (10).

14. Method according to claim 11, wherein in the second recording step the metadata (32) is received through a network, preferably internet.

15. Method according to claim 11, wherein the second recording step is executed before the first recording step.

16. Method for recording a movie (50) comprising video data (51) and metadata (52), the method comprising the steps of:
providing a recordable information carrier (2_{RE}) with the metadata (52) pre-recorded thereon;
in a recording step, recording the video data (51) in association with the metadata (52).

17. Method according to claim 16, wherein in the recording step the video data (51) is received from a broadcast (10).

18. Empty recordable information carrier (2_{RE}) having metadata (52) pre-recorded thereon.

19. Information carrier (2_{RE}) according to claim 18, wherein the information carrier is an optical disc, specifically a BD-RE disc.

20. Information carrier (2_{RE}) according to claim 18, wherein the said metadata (52) is copy-protected.

21. Apparatus (1) for recording data on an information carrier (2_{RE}), the apparatus being capable of performing the method of claim 1.

22. Apparatus (1) for recording data on an information carrier (2_{RE}) in accordance with claim 18, the apparatus being capable of:
receiving a broadcasted video stream (10; 51);
recording the received video stream (51) on the information carrier (2_{RE}) in association with the metadata (52) pre-stored on the carrier (2_{RE}).

23. Apparatus (3) for playing video data (31) of a movie (30) from an information carrier (2_{RE}) and displaying a movie content of said recording on a display device (4), the apparatus comprising an operation memory (6);
the apparatus being capable of communicating, through a communication network, for instance internet (40), with a source (41) for metadata;
wherein the apparatus is designed to, through said communication network, receive metadata (32) associated with the movie (30) and store this metadata (32) in the operation memory (6);
wherein the apparatus is further designed, on the basis of the metadata (32) in its operation memory (6), to read the video data (31) from the information carrier (2_{RE}), and to display the corresponding images on said display (4).

24. Apparatus according to claim 23, wherein the apparatus is further designed to record the received metadata (32) on the information carrier (2_{RE}) in association with the video data (31).

25. Apparatus according to claim 23, wherein the metadata (32) results in BD-ROM functionality.
